(19) United States
(12) Patent Application Publication
(10) Pub. No.: US 2026/0235299 A1
(43) Pub. Date: Aug. 13, 2026

(54) FIREPLACE MANTEL AND RELATED METHODS

(71) Applicant: Douglas A. Baker, Loveland, OH (US)

(72) Inventors: Douglas A. Baker, Loveland, OH (US); Jesse A. Kyle, Milford, OH (US)

(21) Appl. No.: 19/633,147

(22) Filed: Mar. 30, 2026

Related U.S. Application Data
(62) Division of application No. 17/990,971, filed on Nov. 21, 2022, now abandoned.
(60) Provisional application No. 63/281,943, filed on Nov. 22, 2021.

(51) Int. Cl. F24C 15/06; C09D 1/00; C09D 5/03; C09D 5/18

(52) U.S. Cl. CPC F24C 15/06; C09D 1/00; C09D 5/03; C09D 5/18

(57) ABSTRACT

A mantel for a fireplace includes a mantel body and a heat resistant coating. The mantel body has a frame, wherein each portion of the frame is formed of a first heat resistant material. The mantel body also has an overlay housing secured to the frame, wherein each portion of the overlay housing is formed of a second heat resistant material. The heat resistant coating is applied to the mantel body and is more particularly a powder coating.

### CROSS-REFERENCE TO RELATED APPLICATION

This application is a divisional patent application claiming priority to U.S. Pat. App. No. 17/990,971, entitled “Fireplace Mantel and Related Methods,” filed November 21, 2022, published as U.S. Pat. Pub. No. 2023/0160578 on May 25, 2023, which claims priority to U.S. Pat. App. No. 63/281,943, entitled “Fireplace Mantel and Related Methods,” filed November 22, 2021, the disclosure of which is incorporated by reference herein.

### TECHNICAL FIELD

The present invention relates generally to a mantel and related methods and, more particularly, to a mantel for a fireplace and method of manufacturing same.

### BACKGROUND

Fireplace mantels have long been a desirable feature above a firebox of a fireplace, particularly in homes. Functionally, mantels deflect convective and radiant heat from more heat sensitive objects above the mantel. Decoratively, these same mantels may be simple or ornate and provide an additional shelf for placement of additional items of beauty and/or utility to a homeowner. Traditional materials for fireplace mantels, such as wood, brought both of these functional and decorative aspects when used with a classic firebox for burning wood or other combustible fuels and vented with a chimney to remove dangerous exhaust as well as at least some heat from the home.

In more recent years, in an effort to conserve energy as well as improve options for placement of fireplaces within a home, many homeowners prefer vent-free fireplaces. Notably, vent-free fireplaces do not require a vented chimney and may thus be placed anywhere in the home with relatively minor adjustments. In turn, cleaner exhaust is emitted directly into the home rather than lost through the chimney, resulting in greater heating efficiency and reduced operating costs for the homeowner.

Despite these and other benefits from vent-free fireplace design, the additional heat directed into the home tends to rise across the mantel, greatly accelerating heating of the mantel and exposing the mantel to far greater temperatures than more traditional, vented fireplace arrangements. Traditional mantels formed from wood may be damaged or even combust under such high-temperature conditions. By way of example, these traditional mantels may be moved away from the firebox, such as at an elevated height over the firebox, but such positioning fails to protect the area directly above the firebox and may be less aesthetically pleasing to the homeowner. By way of further example, the mantel may be formed of stone or even concrete, but such products may be porous and generally more difficult to decorate and thus less desirable for many homeowners.

Accordingly, there is a need for a fireplace mantel that addresses the present challenges such as those discussed above.

### BRIEF DESCRIPTION OF THE DRAWINGS

While the specification concludes with claims which particularly point out and distinctly claim this technology, it is believed this technology will be better understood from the following description of certain examples taken in conjunction with the accompanying drawings, in which like reference numerals identify the same elements and in which:

FIG. 1 depicts a front view of an example of a fireplace including an exemplary heat resistant mantel secured above a firebox;

FIG. 2 depicts a perspective view of the heat resistant manel of FIG. 1;

FIG. 3 depicts a partially exploded perspective view of the heat resistant manel of FIG. 1;

FIG. 4 depicts a cross-sectional view of the heat resistant mantel of FIG. 1 taken along section line 4-4 of FIG. 2;

FIG. 5 depicts a sectional view of another exemplary heat resistant mantel;

FIG. 5A depicts an enlarged sectional view of the heat resistant mantel of FIG. 5;

FIG. 6 depicts a flowchart of a method of manufacturing the heat resistant manel of FIG. 1;

FIG. 7 depicts a flowchart of applying a powder coating to a mantel body of the heat resistant mantel of FIG. 4 for the method of manufacturing in FIG. 5; and

FIG. 8 depicts a flowchart of applying a mineral paint coating to a mantel body of the heat resistant mantel of FIG. 5 for an alternative method of manufacturing similar to FIG. 5.

The drawings are not intended to be limiting in any way, and it is contemplated that various embodiments of the technology may be carried out in a variety of other ways, including those not necessarily depicted in the drawings. The accompanying drawings incorporated in and forming a part of the specification illustrate several aspects of the present technology, and together with the description serve to explain the principles of the technology; it being understood, however, that this technology is not limited to the precise arrangements shown.

### DETAILED DESCRIPTION

The following description of certain examples of the technology should not be used to limit its scope. Other examples, features, aspects, embodiments, and advantages of the technology will become apparent to those skilled in the art from the following description, which is by way of illustration, one of the best modes contemplated for carrying out the technology. As will be realized, the technology described herein is capable of other different and obvious aspects, all without departing from the technology. Accordingly, the drawings and descriptions should be regarded as illustrative in nature and not restrictive.

It is further understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

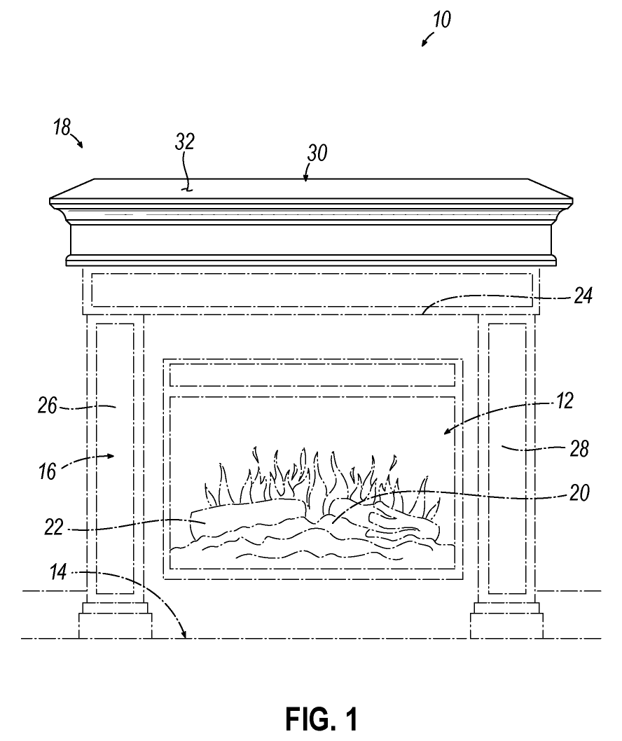

For clarity of disclosure, the terms “upper,” “lower,” “front,” “rear,” “left” and “right” are defined herein relative to a front view of a fireplace as shown in FIG. 1 and that, for convenience and clarity, these spatial terms are used herein for reference to relative positions and directions. Such terms are used below with reference to views as illustrated for clarity and are not intended to limit the invention described herein. Furthermore, the terms “coating” and “paint” each generally refer to an applied material covering a surface.

### I. Exemplary Fireplace with a Heat Resistant Mantel

FIG. 1 shows an example of a fireplace (10) including a firebox (12), a lower hearth (14), a surround (16), and an exemplary, lightweight, heat resistant mantel (18). Firebox (12) contains a vent-free, gas burner (20) shaped to at least some extent to resemble logs (22). Gas burner (20) is configured to be connected to a gas supply (not shown) for receiving combustible gas therefrom. Gas burner (20) is further configured to burn the gas to generate heat, including convective and radiant heat, and release exhaust gas into the surrounding environment, such as a room in a home. In addition, surround (16) includes an upper surround portion including an upper beam (24) as well as left and right surround portions including left and right columns (26, 28), respectively. Mantel (18) includes a lightweight mantel body (30) with a heat resistant coating (32) configured to deflect heat and support objects (not shown) thereon with one or more desired decorative features as discussed below in greater detail. While the present example of firebox (12) is shown configured for vent-free operation with the particular upper beam (24), left and right columns (26, 28), and hearth (14) about the firebox (12), alternative operation, such as vented, as well as designs for surround (16) may be used with mantel (18). The invention is thus not intended to be limited to the particular firebox (12), surround (16), and hearth (14) shown in the present example.

Each of mantle body (30) and heat resistant coating (32) are generally lightweight and formed of materials that are generally non-combustible and resistant to damage from excessive heat, even when placed directly above vent-free firebox (12) as shown in FIG. 1. As used herein, the terms “non-combustible” and “resistant to damage” refer to materials that do not combust nor undergo structural or visual damage below a predetermined maximum threshold, which may be 300 degrees Fahrenheit in one example, 300 degrees Fahrenheit in another example, and 1800 degrees Fahrenheit in yet another example. Such non-combustible materials resistant to damage from heating may thus combust or become damaged at some temperature beyond this predetermined maximum threshold such that the invention is not intended to be wholly non-combustible nor wholly resistant to damage at any elevated temperature. In this respect, mantel body (30) is formed at least partially from non-combustible materials resistant to damage from heating with heat resistant coating (32), which is also formed from non-combustible materials resistant to damage from heating, applied to mantel body (30) to provide functional protection as well as desired aesthetics to the homeowner. While the following illustrates one example of constructing mantel body (30) with heat resistant coating (32), it will be appreciated that alternative design elements and shaping may be similarly used for assembling a mantel body (30) and applying heat resistant coating (32) such that the invention is not intended to be unnecessarily limited to mantle (18) shown in the present example.

### A. Exemplary Heat Resistant Mantel

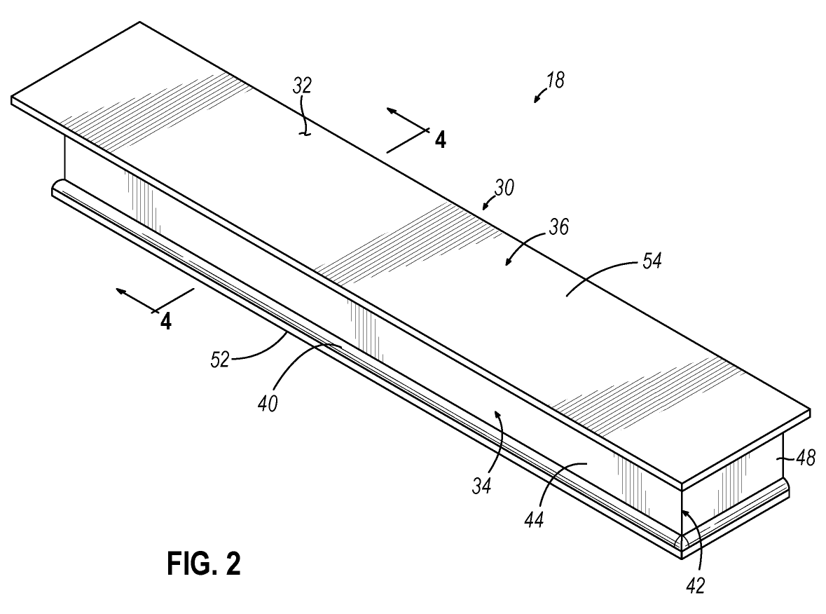

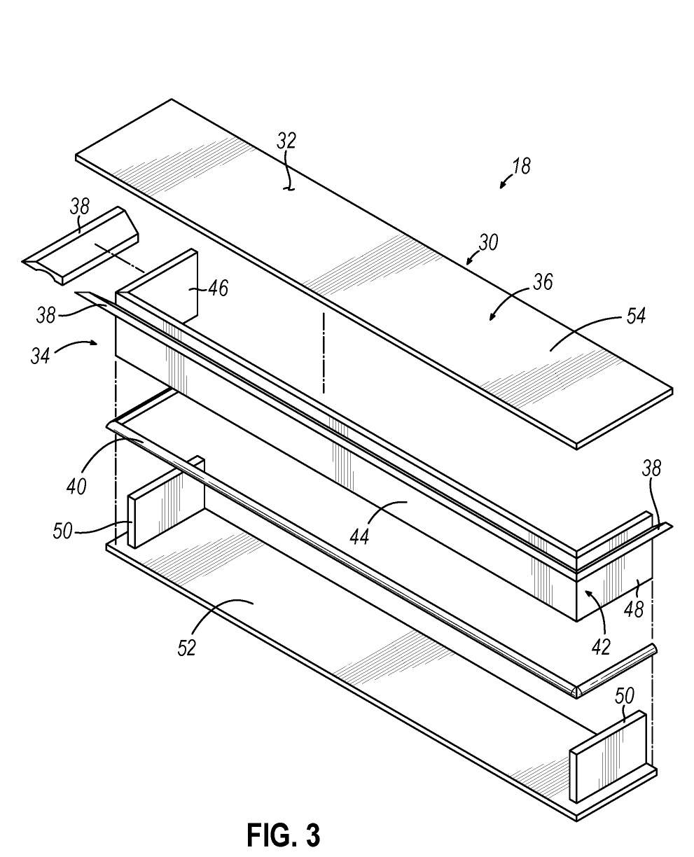

As shown in FIGS. 2-3, mantel (18) includes mantel body (30) having a mantel frame (34), an overlay housing (36), an upper trim (38), and a lower trim (40) as well as heat resistant coating (32) applied to outer surfaces of each of mantel frame (34), overlay housing (36), trims (38, 40), and overlay housing (36). Mantel frame (34) of the present example includes a core (42) having a front elongate member (44) as well as left and right members (46, 48) extending rearwardly from left and right ends of front elongate member (44). To this end, front elongate member (44) and left and right members (46, 48) define a U-shaped cross section when viewed from above. Mantel frame (34) further includes additional internal brace members (50) nested respectively inward of left and right members (46, 48).

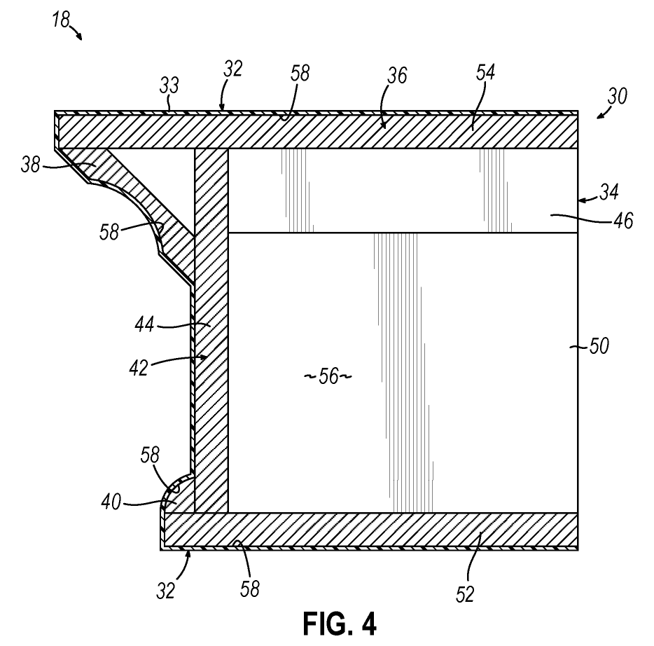

Overlay housing (36) of the present example includes an elongate base member (52) and an elongate shelf member (54) respectively positioned on lower and upper portions of mantel frame (34). Elongate base member (52) is configured to shield heat from upper portions of mantel (18), whereas elongate shelf member (54) is configured to support objects placed thereon. Elongate base member (52), elongate shelf member (54), and mantel frame (34) collectively define a hollow (56) (see FIG. 4) within an interior of mantel (18) for reduced weight. Decoratively, upper trim (38) is placed at the intersection of core (42) and elongate shelf member (54), whereas lower trim (40) is placed at the intersection of core (42) and elongate base member (52).

Upon installation, a bracket (not shown) is received within hollow (56) (see FIG. 4) and configured to be mounted above firebox (12) (see FIG. 1) while mantel frame (34) directly connects to bracket (not shown). In turn, mantel frame (34) rigidly connects to overlay housing (36) and any trim (38, 40) for supporting overlay housing (36) and trim (38, 40) above firebox (12) (see FIG. 1), as well. In the present example, fasteners (not shown), such as nails, are used for rigid connections between connect mantel frame (34), overlay housing (36), and trims (38, 40) for assembly. Alternatively, heat resistant adhesive may be similarly used for assembly. In the present example, each of elongate base member (44) and elongate shelf member (46) as well as front elongate member (40), left and right members (42, 44), and internal brace members (42) are structurally formed so as to bear weight in tension and compression. Thus, while the present example distinguishes mantel frame (34) from overlay housing (36) and trim (38, 40) with respect to a direct connection to bracket (not shown), it will be appreciated that mantel body (30) may be alternatively constructed in any design allowing for mantel body (30) to be secured to bracket (not shown) and, in turn, a wall within a home. The invention is thus not intended to be unnecessarily limited to the particular framings and coverings as shown and described in the present example.

In the present example, each of mantel frame (34), overlay housing (36), upper trim (38), and lower trim (40) are respectively formed of structural calcium silicate so as to be non-combustible and resistant to damage from excessive heat, such as up to 1472 degrees Fahrenheit. More particularly, each of front elongate member (44), left and right members (46, 48), internal brace members (50), elongate base member (52), elongate shelf member (54), upper trim (38), and lower trim (40) is respectively and separately formed of structural calcium silicate, such as by being poured into respective molds or pressed under compression into respective molds. In one example, such members of structural calcium silicate are formed from sheets and/or boards, with such sheets originally being approximately 1/2” (thick) x 4’ x 8’ and such boards originally being approximately 3/4” thick by 3 1/2” wide by 8’. After being formed, front elongate member (44), left and right members (46, 48), internal brace members (50), elongate base member (52), elongate shelf member (54), upper trim (38), and lower trim (40) are assembled as discussed below in greater detail. While the present example shows each of front elongate member (44), left and right members (46, 48), internal brace members (50), elongate base member (52), elongate shelf member (54), upper trim (38), and lower trim (40) formed from the same material, such as structural calcium silicate, less than all of these portions of mantel body (30) may be formed of structural calcium silicate in another example. The mantel body (30) is thus not intended to be unnecessarily limited to being formed entirely of one material, such as structural calcium silicate.

With respect to FIG. 4, mantel body (30) defines an outer surface (58), which includes outer surface portions of mantel frame (34), such as a front surface of core (42), overlay housing (36), such as respective bottom and top surfaces of elongate base member (52) and elongate shelf member (54), as well as outward facing surface of trims (38, 40). Outer surface (58) of mantle body (30) receives heat resistant coating (32) thereon as discussed below in greater detail. In one example, heat resistant coating (32) includes a powder coating (33) configured to be non-combustible and resistant to damage from excessive heat. More particularly, in one example, powder coating (33) is a fluoropolymer powder coating that is non-combustible and resistant to damage up to at least 300 degrees Fahrenheit, such as from approximately 300 degrees Fahrenheit to approximately 500 degrees Fahrenheit. In another example, powder coating (33) is a specialty powder coating non-combustible and resistant to damage up to at least 600 degrees Fahrenheit, such as from approximately 600 degrees Fahrenheit to approximately 800 degrees Fahrenheit. In yet another example, powder coating (33) is a ceramic powder coating non-combustible and resistant to damage up to at least 1800 degrees Fahrenheit. While the present example shown in FIG. 4 illustrates powder coating (33) covering most of outer surface (58), and, more specifically all of outer surface (58), it will be appreciated that less portions of outer surface (58) may be covered in powder coating (33) in other examples. The invention is not intended to be unnecessarily limited to the particular application of powder coating (33) shown in the present example.

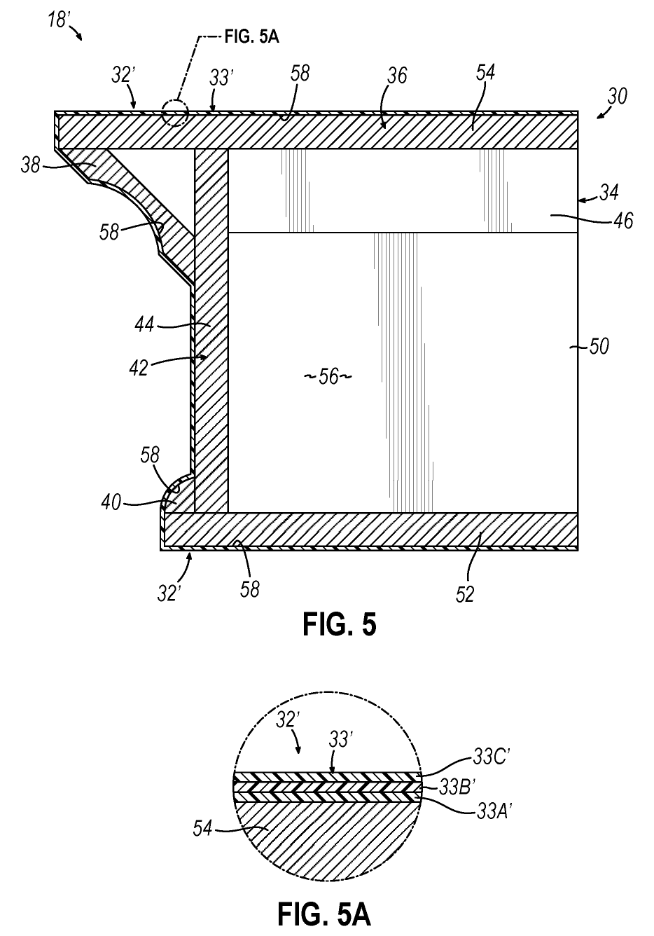

In yet another example shown in FIG. 5, another exemplary, lightweight, heat resistant mantel (18’) includes mantel body (30) with a heat resistant coating (32’) applied thereon. In this respect mantel (18’) is like mantel (18) (see FIG. 4) unless otherwise stated below, and like numbers indicate like features discussed above. Heat resistant coating (32’) more particularly includes a mineral paint coating (33’) configured to be non-combustible and resistant to damage from excessive heat. More particularly, in one example, mineral paint coating (33’) is a modified potassium silicate mineral paint coating that is non-combustible and resistant to damage up to at least 300degrees Fahrenheit. While the present example shown in FIG. 5 illustrates mineral paint coating (33’) covering most of outer surface (58), and, more specifically all of outer surface (58), it will be appreciated that less portions of outer surface (58) may be covered in mineral paint coating (33) in other examples. The invention is not intended to be unnecessarily limited to the particular application of mineral paint coating (33) shown in the present example.

To this end, with mantel body (30) being formed of structural calcium silicate and outer surface (58) covered in heat resistant coating (32) and/or heat resistant coating (32’), mantel (18) is thereby non-combustible and resistant to damage from excessive heat for placement directly above vent-free firebox (12). Mantel (18) of the present example does not include wood, concrete, stone, or metal. Mantel (18) is also not of a single, unitary construction therethrough. Moreover, one or more portions of heat resistant coating (32) and/or heat resistant coating (32’) may be selected from among many available colors or combinations thereof as desired by the homeowner. It will be appreciated that mantel body (30) may thus take many shapes, sizes, and colors while being non-combustible and resistant to damage from excessive heat. Mantels (18, 18’) are thus not intended to be unnecessarily limited to the particular shape, size, and aesthetic designs as shown in the present example.

### B. Exemplary Method of Manufacturing Mantel

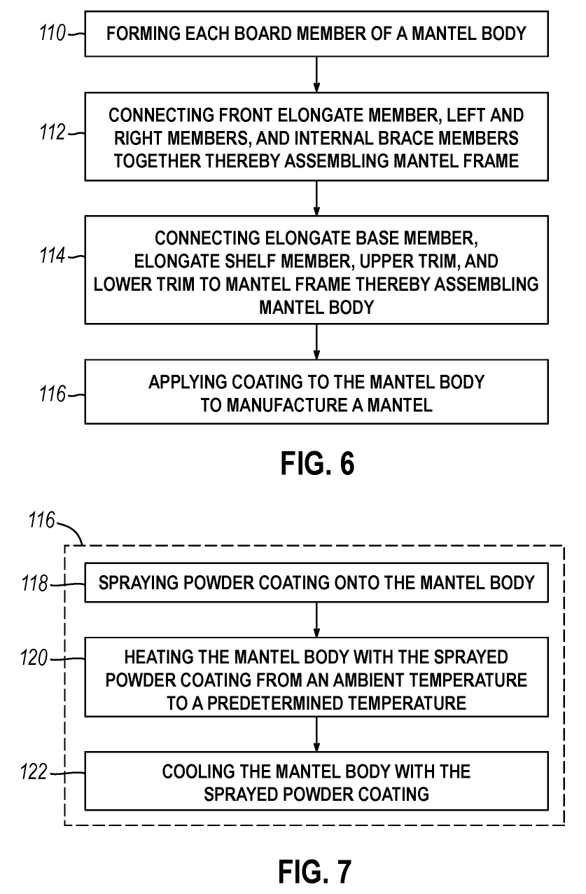

As shown in FIG. 6 and with reference to FIGS. 3 and 4, mantel (18) is manufactured by first forming in a step (110) each respective board member of mantel body (30) from at least one heat resistant material, such as structural calcium silicate. These respective board members of the present example include front elongate member (44), left and right members (46, 48), internal brace members (50), elongate base member (52), elongate shelf member (54), upper trim (38), and lower trim (40) and may be formed in respective molds to a predetermined size and shape, such as being poured into a mold or pressed into a mold under pressure. Alternatively, these board members may be formed more generically to a size and shape and cut to the predetermined size and shape. Again, in the present example, the at least one heat resistant material is structural calcium silicate so as to be non-combustible and resistant to damage from excessive heat, such as up to 1472 degrees Fahrenheit.

After forming respective board members in step (110), front elongate member (44), left and right members (46, 48), and internal brace members (50) are connected together thereby assembling mantel frame (34) in a step (112) and further defining hollow (56) therein. These connections are more particularly rigid connections and may be by fasteners, adhesive, or a combination thereof. Subsequently, in a step (114), elongate base member (52), elongate shelf member (54), upper trim (38), and lower trim (40) are secured to mantel frame (34) thereby assembling mantel body (30).

While the above example assembles various formed portions, mantel body (30) is alternatively be formed from a mold as a single, unitary construction of at least structural calcium silicate. To this end, at least structural calcium silicate is manufactured and utilized as a formable material, such as a powder or a fluid, including as a liquid. This formable material of at least structural calcium silicate is received within a mold for mantel body (30) such that the formable material of at least structural calcium silicate takes a predetermined mold shape of mantel body (30). In one example, this formable material of at least structural calcium silicate in the predetermined mold shape remains in the mold for a predetermined time at a predetermined pressure until sufficiently hardened so as to maintain the predetermined mold shape of mantel body (30) without the surrounding mold. Such predetermined pressure may be no additional pressure, but, in another example, may be an increased pressure above ambient pressures. This formable, and thus moldable, material of at least structural calcium silicate in one example is more particularly at least synthetic hydrated calcium silicate. This formable, and thus moldable, material of at least structural calcium silicate in one example is more particularly at least structural calcium silicate and sodium silicate. In the case of structural calcium silicate, which may more particularly be synthetic hydrated calcium silicate, and sodium silicate, such mixture in one example is approximately 50% structural calcium silicate of weight and approximately 50% sodium silicate by weight and, more particularly, approximately 40% to approximately 50% structural calcium silicate of weight with a remainder being approximately 50% to approximately 60% sodium silicate by weight. The invention is thus not intended to be unnecessarily limited to the arrangement of assembled formed portions as otherwise discussed above and the below description discussed with respect to assembled mantel body (30) and associated coatings may similarly be applied to molded mantel body (30) with such associated coatings.

In one example, after assembling mantel body (30) in step (114), heat resistant coating (32) with powder coating (33) is applied to at least a portion of outer surface (58) of mantel body (30) in a step (116) thereby manufacturing lightweight, heat resistant mantel (18). More particularly, this application of powder coating (33) in the present example of step (116) further includes steps (118, 120, 122) as shown in FIGS. 6 and 7. In step (118), the manufacturer sprays powder coating (33) onto outer surface (58) of mantel body (30) with mantel body (30) at an ambient temperature. After step (118), the manufacturer then heats mantel body (30) to a predetermined temperature in order to further cure powder coating (33) on mantel body (30) in step (120). The manufacturer then cools mantel body (30) from the predetermined temperature back to the ambient temperature to finish curing powder coating (33) on mantel body (30) in step (122) such that powder coating is non-combustible and resistant to damage from excessive heat. In the event that powder coating (33) in step (122) is a fluoropolymer powder coating, powder coating (33) is non-combustible and resistant to damage up to at least 300 degrees Fahrenheit, such as from approximately 300 degrees Fahrenheit to approximately 500 degrees Fahrenheit. In the event that powder coating (33) in step (122) is a specialty powder coating, powder coating (33) is non-combustible and resistant to damage up to at least 600 degrees Fahrenheit, such as from approximately 600 degrees Fahrenheit to approximately 800 degrees Fahrenheit. In the event that powder coating (33) in step (122) is a ceramic powder coating, powder coating (33) is non-combustible and resistant to damage up to at least 1800 degrees Fahrenheit.

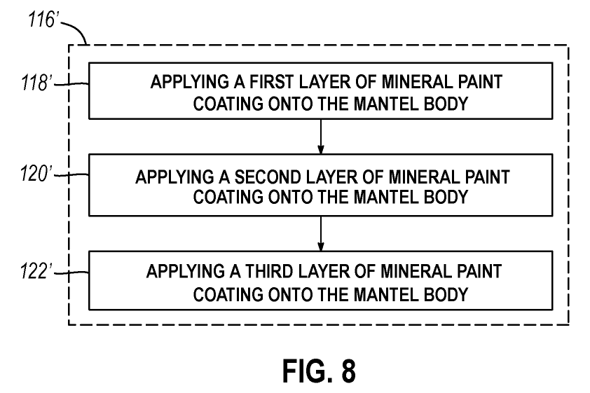

In yet another example, after assembling mantel body (30) in step (114), heat resistant coating (32’) with mineral paint coating (33’) is applied to at least a portion of outer surface (58) of mantel body (30) in a step (116’) in place of, or in addition to, step (116) to thereby manufacture lightweight, heat resistant mantel (18’) as shown in reference to FIG. 5. More particularly, this application of mineral paint coating (33’) in the present example of step (116’) further includes steps (118’, 120’, 122’) as shown in FIG. 8. In step (118’), the manufacturer applies a first layer (33A’) of mineral paint coating (33’) onto outer surface (58) of mantel body (30) with mantel body (30) at an ambient temperature. After step (118’), the manufacturer applies a second layer (33B’) of mineral paint coating (33’) onto outer surface (58) of mantel body (30) with mantel body (30) at an ambient temperature in step (120’). After step (120’), the manufacturer applies a third layer (33C’) of mineral paint coating (33’) onto outer surface (58) of mantel body (30) with mantel body (30) at an ambient temperature in step (122’). First, second, and/or third layers (33A’, 33B’, 33C’) may be applied with a brush, a roller, or by being sprayed on via a sprayer. In one example, third layer (33C’), which is a final layer of mineral paint coating (33’), is applied continuously wet-in-wet and sprayed during application. With such application, mineral paint coating (33’) bonds to outer surface (58) of structural calcium silicate to form heat resistant mantel (18’).

By way of further example, bracket (not shown) may similarly be formed from at least one heat resistant material, such as structural calcium silicate, and optionally receive a heat resistant coating thereon. During installation, bracket (not shown) may then be mounted to wall above firebox (12). Mantel (18, 18’) is then attached to bracket (not shown). Alternatively, in another example, mantel (18) is attached directly to wall without backet (not shown). The invention is thus not intended to be unnecessarily used with bracket (not shown).

### II. Exemplary Combinations

The following examples relate to various non-exhaustive ways in which the teachings herein may be combined or applied. It should be understood that the following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### Example 1

A mantel for a fireplace, comprising: (a) a mantel body, including: (i) a frame, wherein each portion of the frame is formed of a first heat resistant material, and (ii) an overlay housing secured to the frame, wherein each portion of the overlay housing is formed of a second heat resistant material; and (b) a heat resistant coating applied to the mantel body, wherein the heat resistant coating is a powder coating.

### Example 2

The mantel of Example 1, wherein the first heat resistant material is calcium silicate.

### Example 3

The mantel of Example 2, wherein the second heat resistant material is calcium silicate.

### Example 4

The mantel of any one or more of Examples 1 through 3, wherein the powder coating is non-combustible up to at least 300 degrees Fahrenheit.

### Example 5

The mantel of any one or more of Examples 1 through 4, wherein the powder coating is selected from the group consisting of: a specialty powder coating, a fluoropolymer powder coating, and a ceramic powder coating.

### Example 6

The mantel of any one or more of Examples 1 through 5, wherein the powder coating is non-combustible up to at least 300 degrees Fahrenheit.

### Example 7

The mantel of any one or more of Examples 1 through 5, wherein the powder coating is non-combustible up to at least 600 degrees Fahrenheit.

### Example 8

The mantel of any one or more of Examples 1 through 7, wherein the powder coating is a fluoropolymer powder coating.

### Example 9

The mantel of any one or more of Examples 1 through 7, wherein the powder coating is a specialty powder coating.

### Example 10

The mantel of any one or more of Examples 1 through 7, wherein the powder coating is a ceramic powder coating

### Example 11

The mantel of any one or more of Examples 1 through 10, wherein the overlay housing at least partially defines a hollow

### Example 12

The mantel of any one or more of Examples 1 through 11, wherein the second heat resistant material is calcium silicate.

### Example 13

The mantel of any one or more of Examples 1 through 12, wherein the first and second heat resistant materials are the same.

### Example 14

The mantel of any one or more of Examples 1 through 13, wherein the powder coating is non-combustible up to at least 1800 degrees Fahrenheit.

### Example 15

A mantel for a fireplace, comprising: (a) a mantel body, including: (i) a frame, wherein each portion of the frame is formed of a first heat resistant material, and (ii) an overlay housing secured to the frame, wherein each portion of the overlay housing is formed of a second heat resistant material, wherein the mantel body does not include wood, concrete, stone, or metal; and (b) a heat resistant coating applied to the mantel body, wherein the heat resistant coating is a powder coating.

### Example 16

A method of manufacturing a heat resistant mantel for a fireplace, comprising: (a) applying a powder coating to a mantel body thereby manufacturing the heat resistant mantel.

### Example 17

The method of Example 16, wherein at least a portion of the mantel body is formed of calcium silicate.

### Example 18

The method of any one or more of Examples 16 through 17, wherein the mantel body includes a frame and an overlay housing secured to the frame, wherein at least the overlay housing is formed of calcium silicate.

### Example 19

The method of any one or more of Examples 16 through 18, further comprising: (a) forming a plurality of frame members, wherein each of the plurality of frame members is formed of calcium silicate; and (b) connecting the plurality of frame members into a frame of the mantel body.

### Example 20

The method of Example 19, further comprising: (a) forming at least one overlay member, wherein the at least one overlay member is formed of calcium silicate; and (b) securing the at least one overlay member to the frame of the mantel body thereby assembling the mantel body.

### Example 21

The method of any one or more of Examples 16 through 20, further comprising: (a) forming at least one overlay member, wherein the at least one overlay member is formed of calcium silicate.

### Example 22

The method of any one or more of Examples 16 through 21, wherein applying the powder coating further includes: (i) spraying the powder coating onto the mantel body, (ii) heating the mantel body with the powder coating thereon from an ambient temperature to a predetermined temperature, and (iii) cooling the mantel body from the predetermined temperature to the ambient temperature after heating the mantel body thereby curing the powder coating onto the mantel body.

### Example 23

The method of any one or more of Examples 16 through 22, wherein the powder coating after curing is non-combustible up to at least 300 degrees Fahrenheit.

### Example 24

The method of any one or more of Examples 16 through 23, wherein the powder coating is selected from the group consisting of: a specialty powder coating, a fluoropolymer powder coating, and a ceramic powder coating.

### Example 25

The method of any one or more of Examples 16 through 24, wherein at least a portion of the mantel body is formed of calcium silicate.

### Example 26

The method of any one or more of Examples 16 through 25, wherein the powder coating is sprayed directly onto the calcium silicate.

### Example 27

An apparatus, comprising: (a) a body formed of a calcium silicate; and (b) a heat resistant coating applied to the body.

### Example 28

The apparatus of Example 27, wherein the heat resistant coating is a powder coating.

### Example 29

A method of manufacturing an apparatus, comprising: (a) spraying a heat resistant coating onto a body formed of a calcium silicate.

### Example 30

The method of Example 29, wherein the heat resistant coating is a powder coating.

### Example 31

A mantel for a fireplace, comprising: (a) a mantel body, wherein the mantel body does not include wood, concrete, stone, or metal; and (b) a heat resistant coating applied to the mantel body.

### Example 32

The mantel of Example 31, wherein the mantel body includes: (i) a frame, wherein each portion of the frame is formed of a first heat resistant material, and (ii) an overlay housing secured to the frame, wherein each portion of the overlay housing is formed of a second heat resistant material.

### Example 33

The mantel of Example 32, wherein the first heat resistant material is calcium silicate.

### Example 34

The mantel of Example 33, wherein the second heat resistant material is calcium silicate.

### Example 35

The mantel of Example 34, wherein the heat resistant coating is non-combustible up to at least 300 degrees Fahrenheit.

### Example 36

The mantel of Example 35, wherein the heat resistant coating includes a powder coating that is non-combustible up to at least 300 degrees Fahrenheit.

### Example 37

The mantel of Example 31, wherein the heat resistant coating is non-combustible up to at least 300 degrees Fahrenheit.

### Example 38

The mantel of any one or more of Examples 31 through 37, wherein the heat resistant coating includes a ceramic powder coating.

### Example 39

The mantel of any one or more of Examples 31 through 38, wherein the heat resistant coating includes a mineral paint coating.

### Example 40

The mantel of any one or more of Examples 31 through 39, wherein the mantel body at least partially defines a hollow.

### Example 41

A mantel for a fireplace, comprising: (a) a mantel body, including: (i) a frame, wherein each portion of the frame is formed of a first heat resistant material, and (ii) an overlay housing secured to the frame, wherein each portion of the overlay housing is formed of a second heat resistant material; and (b) a heat resistant coating applied to the mantel body, wherein the heat resistant coating includes at least one of a powder coating or a mineral paint coating.

### Example 42

A method of manufacturing a heat resistant mantel for a fireplace, comprising: (a) applying at least one of a powder coating or a mineral paint coating to a mantel body thereby manufacturing the heat resistant mantel.

### Example 43

The method of Example 42, wherein at least a portion of the mantel body is formed of calcium silicate.

### Example 44

The method of Example 43, wherein the mantel body includes a frame and an overlay housing secured to the frame, wherein at least the overlay housing is formed of calcium silicate.

### Example 45

The method of any one or more of Examples 42 through 44, further comprising: (a) forming a plurality of frame members, wherein each of the plurality of frame members is formed of calcium silicate; and (b) connecting the plurality of frame members into a frame of the mantel body.

### Example 46

The method of any one or more of Examples 42 through 45, further comprising: (a) forming the mantel body as a single, unitary construction of calcium silicate.

### Example 47

The method of any one or more of Examples 42 through 46, wherein applying at least one of the powder coating or the mineral paint coating further includes applying the powder coating.

### Example 48

The method of Example 47, wherein applying the powder coating further includes: (i) spraying the powder coating onto the mantel body, (ii) heating the mantel body with the powder coating thereon from an ambient temperature to a predetermined temperature, and (iii) cooling the mantel body from the predetermined temperature to the ambient temperature after heating the mantel body thereby curing the powder coating onto the mantel body.

### Example 49

The method of Example 18, wherein the powder coating after curing is non-combustible up to at least 300 degrees Fahrenheit.

### Example 50

The method of any one or more of Examples 42 through 49, wherein applying at least one of the powder coating or the mineral paint coating further includes applying the mineral paint coating.

### Example 51

A method of manufacturing a heat resistant mantel for a fireplace, comprising: forming the mantel body as a single, unitary construction of at least calcium silicate to thereby manufacture the heat resistant mantel.

### Example 52

The method of Example 51, further comprising applying at least one of a powder coating or a mineral paint coating to a mantel body.

### III. Miscellaneous

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

I/We claim:

1. A mantel for a fireplace, comprising:
(a) a mantel body, wherein the mantel body does not include wood, concrete, stone, or metal; and
(b) a heat resistant coating applied to the mantel body.

2. The mantel of claim 1, wherein the mantel body includes:
(i) a frame, wherein each portion of the frame is formed of a first heat resistant material, and
(ii) an overlay housing secured to the frame, wherein each portion of the overlay housing is formed of a second heat resistant material.

3. The mantel of claim 2, wherein the first heat resistant material is at least calcium silicate.

4. The mantel of claim 3, wherein the second heat resistant material is at least calcium silicate.

5. The mantel of claim 4, wherein the heat resistant coating is non-combustible up to at least 300 degrees Fahrenheit.

6. The mantel of claim 5, wherein the heat resistant coating includes a powder coating that is non-combustible up to at least 300 degrees Fahrenheit.

7. The mantel of claim 1, wherein the heat resistant coating is non-combustible up to at least 300 degrees Fahrenheit.

8. The mantel of claim 1, wherein the heat resistant coating includes a ceramic powder coating.

9. The mantel of claim 1, wherein the heat resistant coating includes a mineral paint coating.

10. The mantel of claim 1, wherein the mantel body at least partially defines a hollow.

11. A mantel for a fireplace, comprising:
(a) a mantel body, including:
(i) a frame, wherein each portion of the frame is formed of a first heat resistant material, and
(ii) an overlay housing secured to the frame, wherein each portion of the overlay housing is formed of a second heat resistant material; and
(b) a heat resistant coating applied to the mantel body, wherein the heat resistant coating includes at least one of a powder coating or a mineral paint coating.

12. A method of manufacturing a heat resistant mantel for a fireplace, comprising:
(a) applying at least one of a powder coating or a mineral paint coating to a mantel body thereby manufacturing the heat resistant mantel.

13. The method of claim 12, wherein at least a portion of the mantel body is formed of at least calcium silicate.

14. The method of claim 13, wherein the mantel body includes a frame and an overlay housing secured to the frame, wherein at least the overlay housing is formed of at least calcium silicate.

15. The method of claim 12, further comprising:
(a) forming a plurality of frame members, wherein each of the plurality of frame members is formed of at least calcium silicate; and
(b) connecting the plurality of frame members into a frame of the mantel body.

16. The method of claim 12, further comprising:
(a) forming the mantel body as a single, unitary construction of at least calcium silicate.

17. The method of claim 12, wherein applying at least one of the powder coating or the mineral paint coating further includes applying the powder coating.

18. The method of claim 17, wherein applying the powder coating further includes:
(i) spraying the powder coating onto the mantel body,
(ii) heating the mantel body with the powder coating thereon from an ambient temperature to a predetermined temperature, and
(iii) cooling the mantel body from the predetermined temperature to the ambient temperature after heating the mantel body thereby curing the powder coating onto the mantel body.

19. The method of claim 18, wherein the powder coating after curing is non-combustible up to at least 300 degrees Fahrenheit.

20. The method of claim 12, wherein applying at least one of the powder coating or the mineral paint coating further includes applying the mineral paint coating.
